(19) United States
(12) Patent Application Publication
(10) Pub. No.: US 2005/0124334 A1
(43) Pub. Date: Jun. 9, 2005

(54) Wireless network and wireless mobile stations using variable fade timer value

(75) Inventor: Purva R. Rajkotia, Plano, TX (US)

Correspondence Address: DOCKET CLERK, P.O. DRAWER 800889, DALLAS, TX, 75380, US

(73) Assignee: SAMSUNG ELECTRONICS Co., LTD., Suwon-city (KR)

(21) Appl. No.: 10/975,147

(22) Filed: Oct. 28, 2004

Related U.S. Application Data
(60) Provisional application No. 60/527,129, filed on Dec. 5, 2003.

(51) Int. Cl. H04Q 7/20

(52) U.S. Cl. 455/422.1

(57) ABSTRACT

A base station for use in a wireless network that communicates with mobile stations in a coverage area of the wireless network. The base station transmits a variable fade timer value to a first mobile station. The variable fade timer value may be modified according to a service being used by the mobile station. The base station comprises a fade timer controller that determines whether the service being used by the mobile station is a voice service or a data service.

### CROSS-REFERENCE TO RELATED APPLICATION AND CLAIM OF PRIORITY

The present invention is related to that disclosed in U.S. Provisional Patent Application Ser. No. 60/527,129, entitled “Wireless Networks and Wireless Mobile Stations Using Variable Fade Timer Value” and filed on Dec. 5, 2003. U.S. Provisional Patent Application Ser. No. 60/527,129 is assigned to the assignee of the present application. The subject matter disclosed in U.S. Provisional Patent Application Ser. No. 60/527,129 is hereby incorporated by reference into the present disclosure as if fully set forth herein. The present invention hereby claims priority under 35 U.S.C. §119(e) to U.S. Provisional Patent Application Ser. No. 60/527,129.

### TECHNICAL FIELD OF THE INVENTION

The present invention is directed, in general, to wireless networks and, more specifically, to CDMA2000 wireless network base stations and wireless mobile stations that use a variable mobile station (MS) fade timer value that varies according to the type of voice or data service.

### BACKGROUND OF THE INVENTION

Businesses and consumers use a wide variety of fixed and mobile wireless terminals, including cell phones, pagers, Personal Communication Services (PCS) systems, and fixed wireless access devices (i.e., vending machine with cellular capability). Wireless service providers create new markets for wireless devices and expand existing markets by making wireless devices and services cheaper and more reliable. Wireless service providers accomplish this, in part, by implementing new services, including digital data services that provide, for example, web browsing and e-mail capabilities.

For many digital data services, it is essential that calls (or data sessions) be set up and broken down as quickly as possible in order to minimize the use of base station resources. The decision of when to break down a call is controlled by a fader timer value established by the base station. In a wireless network, the propagation conditions required for good quality signal communication between base stations and mobile stations cannot always be met due to the irregularities in cell coverage and rapid signal loss. As a result, base stations and mobile stations typically have fade timers that are used to set an amount of time for which the base stations and mobile stations will wait while no good quality signals are being received before declaring a call failure and dropping the call.

Conventional wireless networks, including code division multiple access (CDMA) wireless networks, generally have fade timers programmed to 5 seconds, while conventional base stations generally have fade timers programmed to 10 seconds. The fade timer controls the transmitters in the mobile stations and base stations. During a call, a mobile station turns off its transmitter circuitry and resets the fade timer. The receiver circuitry of the mobile station then monitors the traffic channel to see if two consecutive good frames are received before the fade timer expires.

If two consecutive good frames are received, the mobile station turns on the transmitter circuitry and responds, if necessary. If two consecutive good frames are not received before the 5-second fade timer expires, then the mobile station drops the call and the receiver circuitry begins monitoring the paging channel to see if a new call has been received.

The 5-second fade timer value used in the prior art wireless networks was designed (or selected) with conventional or legacy voice services in mind. The 5-second fade timer value was not selected with fast setup packet data and voice services in mind. As more and more data users load a wireless network, the fade timer requirement of 5 seconds may hamper the performance of the wireless network.

Therefore, there is a need in the art for improved wireless networks and improved wireless terminals for accessing the wireless networks. In particular, there is a need for CDMA2000 wireless network base stations and wireless mobile stations that are not hampered by the use of 5-second fade timer values.

### SUMMARY OF THE INVENTION

The present invention overcomes the shortcomings of conventional wireless networks by implementing a variable mobile station (MS) fade timer value. According to the principles of the present invention, the value of the variable MS fade timer value is controlled by the base station and depends on the type of service (packet data, voice, etc.) being used by the mobile station.

To address the above-discussed deficiencies of the prior art, it is a primary object of the present invention to provide a base station for use in a wireless network capable of communicating with a plurality of mobile stations in a coverage area of the wireless network. According to an advantageous embodiment of the present, the base station is capable of transmitting a variable fade timer value to a first mobile station, wherein the variable fade timer value may be modified according to a service being used by the mobile station.

According to one embodiment of the present invention, the base station comprises a fade timer controller capable of determining whether the service being used by mobile station is one of i) a voice service and ii) a data service.

According to another embodiment of the present invention, the fade timer controller, in response to a determination that the mobile station is using a data service, causes the base station to transmit to the mobile station a variable fade timer value that is shorter than a fade timer value associated with a voice service.

According to still another embodiment of the present invention, the base station transmits the variable fade timer value to the mobile station in a forward control channel message.

According to yet another embodiment of the present invention, the forward control channel message is a special-purpose message.

According to a further embodiment of the present invention, the wireless network comprises a CDMA2000 network and the forward control channel message is one of an Extended Channel Assignment message, a Universal Hand-off Direction message, or a Service Connect message.

It is another primary object of the present invention to provide a mobile station capable of accessing a wireless network comprising a plurality of base stations that communicate with mobile stations in a coverage area of the wireless network. The mobile station comprises a programmable fade timer and the mobile station is capable of receiving from a first one of the plurality of base stations a variable fade timer value for use by the programmable fade timer.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention and its advantages, reference is now made to the following description taken in conjunction with the accompanying drawings, in which like reference numerals represent like parts:

FIG. 1 illustrates an exemplary wireless network, which uses a variable mobile station (MS) fade timer value according to the principles of the present invention;

FIG. 2 illustrates in greater detail an exemplary base station that controls a variable MS fade timer value according to the principles of the present invention; and

FIG. 3 illustrates in greater detail an exemplary wireless mobile station that uses a variable MS fade timer value according to the principles of the present invention.

### DETAILED DESCRIPTION OF THE INVENTION

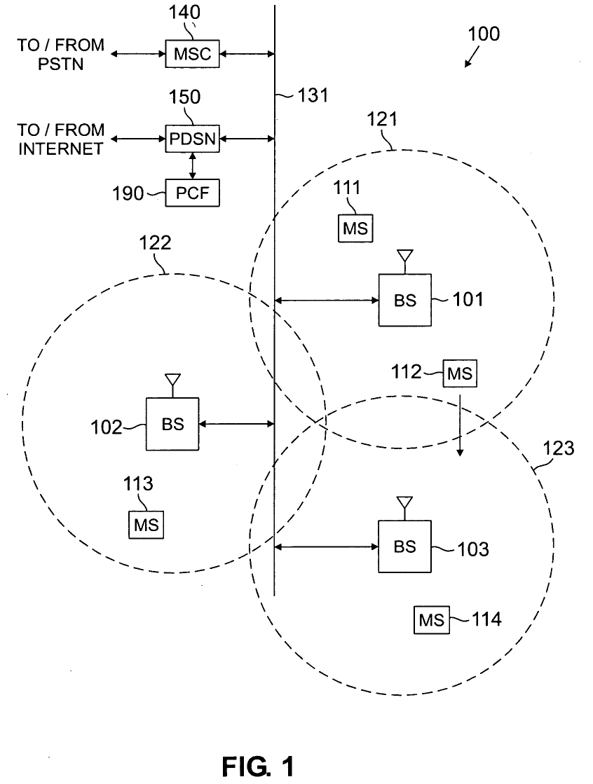

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged wireless network.

FIG. 1 illustrates exemplary wireless network 100, which uses a variable mobile station (MS) fade timer value according to the principles of the present invention. Wireless network 100 comprises a plurality of cell sites 121-123, each containing one of the base stations, BS 101, BS 102, or BS 103. Base stations 101-103 communicate with a plurality of mobile stations (MS) 111-114 over code division multiple access (CDMA) channels according to, for example, the IS-2000 standard (i.e., CDMA2000). In an advantageous embodiment of the present invention, mobile stations 111-114 are capable of receiving data traffic and/or voice traffic on two or more CDMA channels simultaneously. Mobile stations 111-114 may be any suitable wireless devices (e.g., conventional cell phones, PCS handsets, personal digital assistant (PDA) handsets, portable computers, telemetry devices) that are capable of communicating with base stations 101-103 via wireless links.

The present invention is not limited to mobile devices. The present invention also encompasses other types of wireless access terminals, including fixed wireless terminals. For the sake of simplicity, only mobile stations are shown and discussed hereafter. However, it should be understood that the use of the term “mobile station” in the claims and in the description below is intended to encompass both truly mobile devices (e.g., cell phones, wireless laptops) and stationary wireless terminals (e.g., a machine monitor with wireless capability).

Dotted lines show the approximate boundaries of cell sites 121-123 in which base stations 101-103 are located. The cell sites are shown approximately circular for the purposes of illustration and explanation only. It should be clearly understood that the cell sites may have other irregular shapes, depending on the cell configuration selected and natural and man-made obstructions.

As is well known in the art, each of cell sites 121-123 is comprised of a plurality of sectors, where a directional antenna coupled to the base station illuminates each sector. The embodiment of FIG. 1 illustrates the base station in the center of the cell. Alternate embodiments may position the directional antennas in corners of the sectors. The system of the present invention is not limited to any particular cell site configuration.

In one embodiment of the present invention, each of BS 101, BS 102 and BS 103 comprises a base station controller (BSC) and one or more base transceiver subsystem(s) (BTS). Base station controllers and base transceiver subsystems are well known to those skilled in the art. A base station controller is a device that manages wireless communications resources, including the base transceiver subsystems, for specified cells within a wireless communications network. A base transceiver subsystem comprises the RF transceivers, antennas, and other electrical equipment located in each cell site. This equipment may include air conditioning units, heating units, electrical supplies, telephone line interfaces and RF transmitters and RF receivers. For the purpose of simplicity and clarity in explaining the operation of the present invention, the base transceiver subsystems in each of cells 121, 122 and 123 and the base station controller associated with each base transceiver subsystem are collectively represented by BS 101, BS 102 and BS 103, respectively.

BS 101, BS 102 and BS 103 transfer voice and data signals between each other and the public switched telephone network (PSTN) (not shown) via communication line 131 and mobile switching center (MSC) 140. BS 101, BS 102 and BS 103 also transfer data signals, such as packet data, with the Internet (not shown) via communication line 131 and packet data server node (PDSN) 150. Packet control function (PCF) unit 190 controls the flow of data packets between base stations 101-103 and PDSN 150. PCF unit 190 may be implemented as part of PDSN 150, as part of MSC 140, or as a stand-alone device that communicates with PDSN 150, as shown in FIG. 1. Line 131 also provides the connection path for control signals transmitted between MSC 140 and BS 101, BS 102 and BS 103 that establish connections for voice and data circuits between MSC 140 and BS 101, BS 102 and BS 103.

Communication line 131 may be any suitable connection means, including a T1 line, a T3 line, a fiber optic link, a network packet data backbone connection, or any other type of data connection. Line 131 links each vocoder in the BSC with switch elements in MSC 140. The connections on line 131 may transmit analog voice signals or digital voice signals in pulse code modulated (PCM) format, Internet Protocol (IP) format, asynchronous transfer mode (ATM) format, or the like.

MSC 140 is a switching device that provides services and coordination between the subscribers in a wireless network and external networks, such as the PSTN or Internet. MSC 140 is well known to those skilled in the art. In some embodiments of the present invention, communications line 131 may be several different data links where each data link couples one of BS 101, BS 102, or BS 103 to MSC 140.

In the exemplary wireless network 100, MS 111 is located in cell site 121 and is in communication with BS 101. MS 113 is located in cell site 122 and is in communication with BS 102. MS 114 is located in cell site 123 and is in communication with BS 103. MS 112 is also located close to the edge of cell site 123 and is moving in the direction of cell site 123, as indicated by the direction arrow proximate MS 112. At some point, as MS 112 moves into cell site 123 and out of cell site 121, a hand-off will occur.

According to the principles of the present invention, wireless network 100 and the mobile stations accessing wireless network 100 implement variable mobile station (MS) fade timer values that are controlled by the base station. The selected fade timer value depends on the type of service (packet data, voice, etc.) being used by the mobile station. Hence, for data services, a base station specifies the value the base station wants to use for the mobile station (MS) fade timer. Generally, the MS fade timer value for data services is expected to be less than the conventional 5 second value used for voice services.

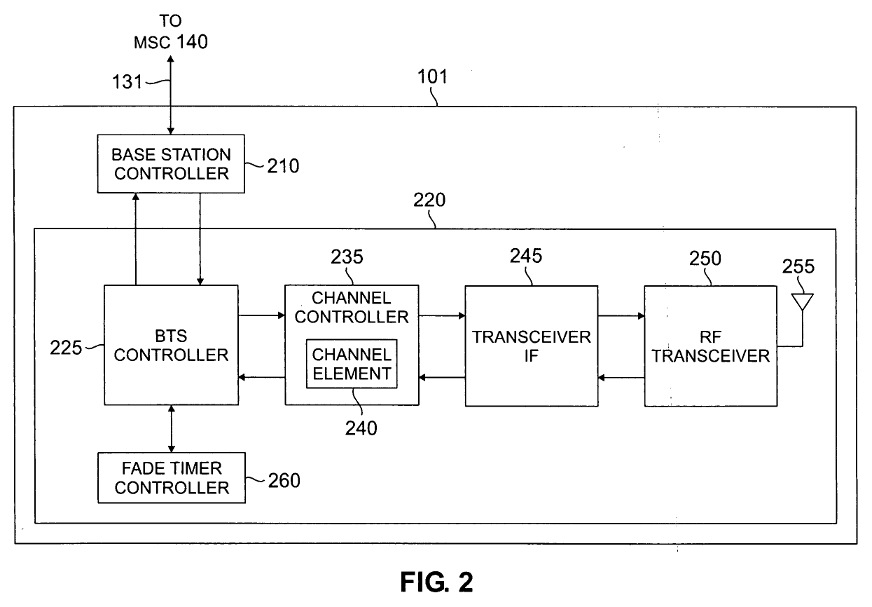

FIG. 2 illustrates in greater detail exemplary base station (BS) 101, which controls a variable MS fade timer value according to the principles of the present invention. Base station 101 comprises base station controller (BSC) 210 and base transceiver station (BTS) 220. Base station controllers and base transceiver stations were described previously in connection with FIG. 1. BSC 210 manages the resources in cell site 121, including BTS 220. BTS 120 comprises BTS controller 225, channel controller 235 (which contains representative channel element 240), transceiver interface (IF) 245, RF transceiver unit 250, antenna array 255, and fade timer controller 260.

BTS controller 225 comprises processing circuitry and memory capable of executing an operating program that controls the overall operation of BTS 220 and communicates with BSC 210. Under normal conditions, BTS controller 225 directs the operation of channel controller 235, which contains a number of channel elements, including channel element 240, that perform bi-directional communications in the forward channel and the reverse channel. A “forward” channel refers to outbound signals from the base station to the mobile station and a “reverse” channel refers to inbound signals from the mobile station to the base station. Transceiver IF 245 transfers the bi-directional channel signals between channel controller 240 and RF transceiver unit 250.

Antenna array 255 transmits forward channel signals received from RF transceiver unit 250 to mobile stations in the coverage area of BS 101. Antenna array 255 also sends to transceiver 250 reverse channel signals received from mobile stations in the coverage area of BS 101. In a preferred embodiment of the present invention, antenna array 255 is multi-sector antenna, such as a three-sector antenna in which each antenna sector is responsible for transmitting and receiving in a 120° arc of coverage area. Additionally, transceiver 250 may contain an antenna selection unit to select among different antennas in antenna array 255 during both transmit and receive operations.

According to the principles of the present invention, fade timer controller 260 is capable of adjusting the fade timer value used by the mobile station (e.g., MS 111) depending on the type of service (packet data, voice, etc.) being used by the mobile station. For data services, fade timer controller 260 specifies a value for the mobile station (MS) fade timer. Fade timer controller 260 may set (or reset) the variable fade timer value at the start of a data session or during the data session as data traffic levels change, as a result of a handoff, or if the mobile station invokes a new data service.

According to the principles of the present invention, fade timer controller 260 may assign a variable MS fade timer value to a mobile station using, for example, one or more of the Extended Channel Assignment message (ECAM), the Universal Handoff Direction message (UHDM), and the Service Connect message (SCM). Alternatively, fade timer controller 260 may assign a variable MS fade timer value to a mobile station using a special-purpose forward channel message. If fade timer controller 260 does not specify a variable MS fade timer value in any one of the ECAM, UDHM or SCM, then the mobile station may use the default timer value of 5 seconds.

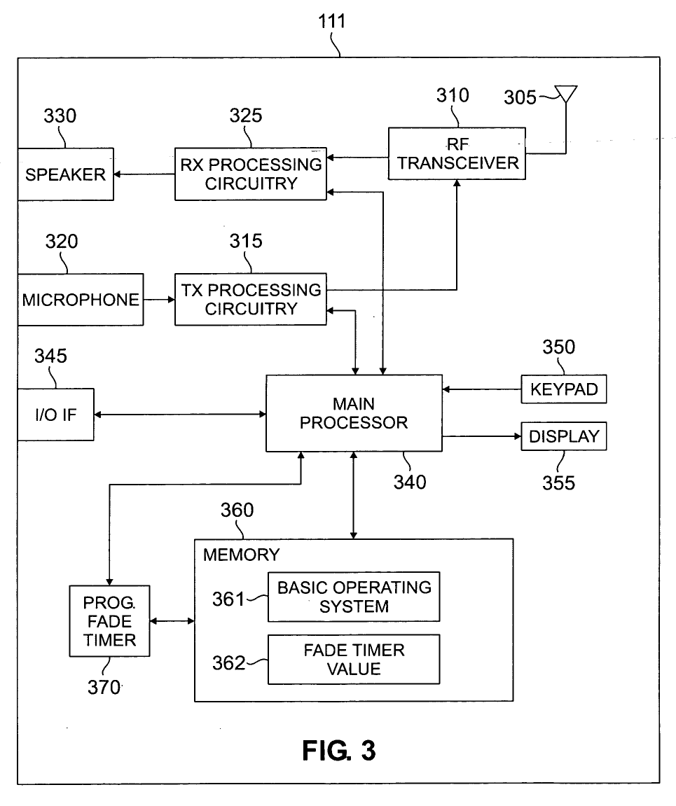

FIG. 3 illustrates in greater detail exemplary wireless mobile station 111, which uses a variable MS fade timer value according to the principles of the present invention. Wireless mobile station 111 comprises antenna 305, radio frequency (RF) transceiver 310, transmit (TX) processing circuitry 315, microphone 320, and receive (RX) processing circuitry 325. MS 111 also comprises speaker 330, main processor 340, input/output (I/O) interface (IF) 345, keypad 350, display 355, memory 360, and programmable fade timer 370. Memory 360 stores basic operating system (OS) program 361 and Fade Timer Value 362.

Radio frequency (RF) transceiver 310 receives from antenna 305 an incoming RF signal transmitted by a base station of wireless network 100. Radio frequency (RF) transceiver 310 down-converts the incoming RF signal to produce an intermediate frequency (IF) or a baseband signal. The IF or baseband signal is sent to receiver (RX) processing circuitry 325 that produces a processed baseband signal by filtering, decoding, and/or digitizing the baseband or IF signal. Receiver (RX) processing circuitry 325 transmits the processed baseband signal to speaker 330 (i.e., voice data) or to main processor 340 for further processing (e.g., web browsing).

Transmitter (TX) processing circuitry 315 receives analog or digital voice data from microphone 320 or other outgoing baseband data (e.g., web data, e-mail, interactive video game data) from main processor 340. Transmitter (TX) processing circuitry 315 encodes, multiplexes, and/or digitizes the outgoing baseband data to produce a processed baseband or IF signal. Radio frequency (RF) transceiver 310 receives the outgoing processed baseband or IF signal from transmitter (TX) processing circuitry 315. Radio frequency (RF) transceiver 310 up-converts the baseband or IF signal to a radio frequency (RF) signal that is transmitted via antenna 305.

In an advantageous embodiment of the present invention, main processor 340 is a microprocessor or microcontroller. Memory 360 is coupled to main processor 340. According to an advantageous embodiment of the present invention, part of memory 360 comprises a random access memory (RAM) and another part of memory 360 comprises a Flash memory, which acts as a read-only memory (ROM).

Main processor 340 executes basic operating system (OS) program 361 stored in memory 360 in order to control the overall operation of wireless mobile station 111. In one such operation, main processor 340 controls the reception of forward channel signals and the transmission of reverse channel signals by radio frequency (RF) transceiver 310, receiver (RX) processing circuitry 325, and transmitter (TX) processing circuitry 315, in accordance with well-known principles.

Main processor 340 is capable of executing other processes and programs resident in memory 360. Main processor 340 can move data into or out of memory 360, as required by an executing process. Main processor 340 is also coupled to I/O interface 345. I/O interface 345 provides mobile station 111 with the ability to connect to other devices, such as laptop computers and handheld computers. I/O interface 345 is the communication path between these accessories and main controller 340.

Main processor 340 is also coupled to keypad 350 and display unit 355. The operator of mobile station 111 uses keypad 350 to enter data into mobile station 111. Display 355 may be a liquid crystal display capable of rendering text and/or at least limited graphics from web sites. Alternate embodiments may use other types of displays.

Main processor 340 also controls and monitors programmable fade timer 370. Main processor 340 receives forward control channel messages (e.g., ECAM, UDHM or SCM) transmitted by BS 101 from RX processing circuitry 325. These control channel messages may include a variable fade timer value that main processor 340 stores in Fade Timer Value 362. If BS 101 does not transmit a variable MS fade timer value, then main processor 360 may use a default timer value of 5 seconds.

Main processor 340 enables programmable fade timer 370 when MS 111 starts receiving bad frames. When MS 111 receives consecutive bad frames, main processor 340 disables the transmitter circuitry in RF transceiver 310. The time period for which main processor 340 disables the transmitter circuitry depends on the base station-selected value stored in Fade Timer Value 370. During handoffs, if MS 111 goes from one base station to another, the timer value changes according to the new timer value specified by the target base station in the UHDM/GHDM.

The present invention improves the performance of packet data calls. When the mobile station is engaged in a packet data call, using a typical fade timer value of 5 seconds has significant drawbacks. It degrades the performance of the packet data call, since the mobile station must wait 5 seconds before determining a call failure. Using the present invention, the mobile station determines a call failure in a shorter period of time and reconnects to a new traffic channel more rapidly.

Although the present invention has been described with an exemplary embodiment, various changes and modifications may be suggested to one skilled in the art.

1. For use in a wireless network capable of communicating with a plurality of mobile stations in a coverage area of said wireless network, a base station capable of transmitting a variable fade timer value to a first one of said plurality of mobile stations, wherein said base station modifies said variable fade timer value according to a service being used by said first mobile station.

2. The base station as set forth in claim 1, wherein said base station comprises a fade timer controller capable of determining whether said service being used by said first mobile station is one of i) a voice service and ii) a data service.

3. The base station as set forth in claim 2, wherein said fade timer controller, in response to a determination that said first mobile station is using a data service, causes said base station to transmit to said first mobile station a variable fade timer value that is shorter than a fade timer value associated with a voice service.

4. The base station as set forth in claim 3, wherein said base station transmits said variable fade timer value to said first mobile station in a forward control channel message.

5. The base station as set forth in claim 4, wherein said forward control channel message is a special-purpose message.

6. The base station as set forth in claim 4, wherein said wireless network comprises a CDMA2000 network.

7. The base station as set forth in claim 6, wherein said base station transmits said variable fade timer value to said first mobile station in an Extended Channel Assignment message.

8. The base station as set forth in claim 6, wherein said base station transmits said variable fade timer value to said first mobile station in a Universal Hand-off Direction message.

9. The base station as set forth in claim 6, wherein said base station transmits said variable fade timer value to said first mobile station in a Service Connect message.

10. A wireless network comprising:
a plurality of base stations capable of communicating with a plurality of mobile stations in a coverage area of said wireless network, wherein a first one of said plurality of base stations is capable of transmitting a variable fade timer value to a first one of said plurality of mobile stations, wherein said first base station modifies said variable fade timer value according to a service being used by said first mobile station.

11. The wireless network as set forth in claim 10, wherein said first base station comprises a fade timer controller capable of determining whether said service being used by said first mobile station is one of i) a voice service and ii) a data service.

12. The wireless network as set forth in claim 11, wherein said fade timer controller, in response to a determination that said first mobile station is using a data service, causes said first base station to transmit to said first mobile station a variable fade timer value that is shorter than a fade timer value associated with a voice service.

13. The wireless network as set forth in claim 12, wherein said first base station transmits said variable fade timer value to said first mobile station in a forward control channel message.

14. The wireless network as set forth in claim 13, wherein said forward control channel message is a special-purpose message.

15. The wireless network as set forth in claim 13, wherein said wireless network comprises a CDMA2000 network.

16. The wireless network as set forth in claim 15, wherein said first base station transmits said variable fade timer value to said first mobile station in an Extended Channel Assignment message.

17. The wireless network as set forth in claim 15, wherein said first base station transmits said variable fade timer value to said first mobile station in a Universal Hand-off Direction message.

18. The wireless network as set forth in claim 15, wherein said first base station transmits said variable fade timer value to said first mobile station in a Service Connect message.

19. A mobile station capable of accessing a wireless network comprising a plurality of base stations that communicate with mobile stations in a coverage area of the wireless network, wherein said mobile station comprises a programmable fade timer and said mobile station is capable of receiving from a first one of said plurality of base stations a variable fade timer value for use by said programmable fade timer.

20. The mobile station as set forth in claim 19, wherein said mobile station receives said variable fade timer value from said first base station in a forward control channel message.

21. The mobile station as set forth in claim 20, wherein said forward control channel message is a special-purpose message.

22. A method for use in a wireless network capable of communicating with a plurality of mobile stations in a coverage area of said wireless network, the method comprising the steps of:
determining a type of service being used by a first mobile station;
modifying a variable fade timer value according to the type of service being used by the first mobile station; and
transmitting the variable fade timer value from a first one of the plurality of base stations to the first mobile station.
